(19) United States
(12) Patent Application Publication
(10) Pub. No.: US 2008/0274407 A1
(43) Pub. Date: Nov. 6, 2008

(54) Layered carbon electrodes for capacitive deionization and methods of making the same

(76) Inventors: Roy Joseph Bourcier, Corning, NY (US); Prantik Mazumder, Ithaca, NY (US); Vitor Marino Schneider, Painted Post, NY (US); Todd P. St Clair, Painted Post, NY (US)

Correspondence Address: CORNING INCORPORATED, SP-TI-3-1, CORNING, NY, 14831, US

(21) Appl. No.: 11/799,901

(22) Filed: May 3, 2007

(51) Int. Cl. H01M 4/38; B32B 37/00

(52) U.S. Cl. 429/231.8; 156/276

(57) ABSTRACT

Layered carbon electrodes for use in, for example, Capacitive Deionization (CDI) of a fluid stream or, for example, an electric double layer capacitor (EDCL). Methods of making the layered carbon electrodes are also described. The layered carbon electrode comprises an electrically conductive porous layer and an adjacent layer comprising carbon particles in contact with the electrically conductive porous layer. A thermoplastic material is infused in the electrically conductive porous layer and provides a bond to the carbon particles at the interface of the electrically conductive porous layer and the adjacent layer comprising carbon particles.

### BACKGROUND

1. Field of the Invention

The present invention relates generally to carbon electrodes and more particularly to a layered carbon electrode useful for capacitive deionization and methods of making the same.

2. Technical Background

Capacitive Deionization (CDI) is a promising technology, for instance, for the purification of water. In this context, positively and negatively charged electrodes are used to attract ions from a stream or bath of fluid. The ions form electric double layers on the surfaces of the electrodes, which are fabricated from some form of high surface area material, for example, a form of activated carbon. After passing over the electrodes, the fluid contains a lower overall ion content and is discharged. A volume of purge fluid is then introduced to the electrodes. The electrodes are then electrically discharged, thus releasing the trapped ions into the purge fluid. The purge fluid is then diverted into a waste stream and the process repeated.

In U.S. Pat. No. 5,954,937, CDI electrodes are described which are based on a resorcinol/formaldehyde carbon aerogel technology. Carbon paper sheets are soaked with a polymer resorcinol/formaldehyde resin and subsequently pyrolyzed. Sol-gel processing and supercritical drying are traditionally used to obtain an aerogel structure prior to pyrolysis. The resulting electrodes are thin, monolithic carbon structures. The aerogel surface of these electrode sheets and the carbon paper itself are delicate and need to be protected from mechanical stressing which can cause damage to the electrodes, rendering the electrodes inoperable.

The electrodes are then bonded to a titanium sheet current collector using a conductive carbon filled adhesive. The large area of contact between the electrode and the current collector ensures relatively low overall resistance despite the moderately high resistivity of the adhesive interface. The resulting electrodes possess good CDI performance, but are extremely costly. Limited success has been achieved at applying subcritical drying to reduce cost. Also, these electrodes possess a very modest level of total capacitance per unit area, since the aerogel layer is thin and possesses limited surface area. This reduced level of capacitance increases the number of electrode sheets required for a given system which further increases the cost.

In U.S. Pat. No. 6,778,378, electrodes are described which are fabricated by blending activated carbon powder, fibrillated polytetrafluoroethylene (PTFE) and a liquid, forming a paste-like material. The resulting paste-like material is then rolled into a composite sheet. Electrodes formed in this fashion are thin, flexible sheets with good specific capacitance. A large fraction of this capacitance value is a result of the activated carbon used.

However, the particle to particle connectivity of the carbon particles in the activated carbon is typically poor and these electrodes have high electronic resistance compared to the monolithic aerogel electrodes. A separate current collector sheet, typically made of rolled exfoliated graphite material, is clamped to the electrode back surface with a large compressive force to obtain the necessary electrical performance, thus increasing the cost and the complexity of a CDI device made using these electrodes. Also these rolled composite sheets, due to the purely mechanical nature of the PTFE/carbon bonding, have only modest erosion resistance. For this reason, when eliminating particulates from the fluid stream, the flow rates of the fluid stream need to be minimized across the surface of these electrodes.

A flow-through (rather than parallel plate) flow geometry is described in commonly owned U.S. Pat. No. 6,214,204, the disclosure of which is incorporated herein by reference in its entirety. In this reference, monolithic, low back pressure porous electrodes are made by one of several methods, which include honeycomb extrusion, casting or molding from a phenolic resin-based batch. After curing, these parts are carbonized and activated to create high surface area carbon monoliths with good electrical conductivity.

The resulting electrodes have some disadvantages, for example, limited mechanical strength, since the electrodes comprise a porous and brittle material. Thus, manufacturing thin, large diameter electrodes for high performance is challenging and packaging the electrodes into a CDI system is also challenging. Also, because they do not have a conductive graphitic backplane, their electronic conductivity is low as compared to the carbon paper-based aerogel electrodes.

It would be advantageous to develop cost-effective, electrochemically inert and mechanically robust electrodes with high specific capacitance and low electrical resistance. Also, it would be advantageous for the electrodes to be easily processed into different geometries which could enable various fluidic schemes.

### SUMMARY

Layered carbon electrodes useful for capacitive deionization and methods of making the same are described herein. The carbon electrodes useful for CDI and the methods of making the carbon electrodes of the present invention as described herein, address one or more of the above-mentioned disadvantages of the conventional electrodes.

In one embodiment, a layered carbon electrode is disclosed. The layered carbon electrode comprises an electrically conductive porous layer and an adjacent layer comprising carbon particles in contact with the electrically conductive porous layer. A thermoplastic material is infused in the electrically conductive porous layer and provides a bond to the carbon particles at the interface of the electrically conductive porous layer and the adjacent layer comprising carbon particles.

According to another embodiment, a method of making the layered carbon electrode is disclosed. The method comprises providing an electrically conductive porous layer, infusing the electrically conductive porous layer with a thermoplastic material, applying a layer comprising carbon particles to the electrically conductive porous layer infused with the thermoplastic material, and compressing and heating the layers such that the thermoplastic material wicks from the electrically conductive porous layer to bond with the carbon particles at the interface of the layers.

According to another embodiment, a multilayered carbon electrode is disclosed. The multilayered carbon electrode comprises a first outer layer of an electrically conductive porous layer, a first intermediate adjacent layer comprising carbon particles in contact with the first outer layer, a second outer layer of an electrically conductive porous layer, a second intermediate adjacent layer comprising carbon particles in contact with the second outer layer and a non-conductive porous inner layer in contact with the first and second intermediate layers on opposing sides of the non-conductive porous inner layer. A thermoplastic material is infused in the first and second electrically conductive porous layers and provides a bond to the carbon particles at the interface of the electrically conductive porous layers and the adjacent first and second intermediate layers, respectively.

Layered carbon electrodes made according to the methods described herein possess one or more desirable advantages, for example, the electrically conductive porous layer can provide a high performance electrical backplane for the carbon electrode. The thermoplastic material which is infused in the electrically conductive porous layer can improve the mechanical integrity of the carbon electrode by toughening the otherwise brittle electrically conductive porous layer. Also, increased electrical contact between the carbon particles in the adjacent layer and the electrically conductive porous layer can be achieved and maintained in the final carbon electrode, thus yielding a carbon electrode with low electronic resistance. The electrically conductive porous layer, once infused with the thermoplastic material, serves as a reservoir to bond the carbon particles to the electrical backplane (electrically conductive porous layer). No additional material, which could compromise the electrical continuity of the layers, is required to bond the carbon particles to the electrical backplane. The carbon electrodes of the present invention possess increased fluidic access to the carbon particles (e.g. high surface area carbon powder) which is maintained in the final carbon electrode. Capillary bonding of the thermoplastic material to the carbon particles from the thermoplastic infused electrically conductive porous layer enables the exposed surface of the carbon particles to be uncontaminated by the thermoplastic material.

Further advantages of layered carbon electrodes according to the present invention are that the layered carbon electrodes and methods of making the layered carbon electrodes can utilize a range of different carbon powders, providing an opportunity for performance enhancement and/or fine tuning. The mechanical properties, for example, strength and integrity of the carbon electrodes (relative to conventional CDI electrodes) enable the carbon electrodes of the present invention to easily be used in parallel, transverse, or hybrid parallel/transverse flow geometries. The methods of making the carbon electrodes and the inexpensive components result in carbon electrodes which can be increasingly cost-effective.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawing figures.

FIG. 1 is an illustration of a cross section of an electrically conductive porous layer in contact with a layer comprising carbon particles.

FIG. 2 is a scanning electron microscope (SEM) image of a top down view of a layered carbon electrode according to one embodiment.

FIG. 3 is a schematic of a method of making a carbon electrode according to one embodiment.

FIG. 4A is a graph of the electrochemical impedance spectroscopy (EIS) test results for a commercially available double layer capacitor.

FIG. 4B is a graph of the electrochemical impedance spectroscopy (EIS) test results for a carbon electrode according to one embodiment.

FIG. 5 is a photograph of a carbon electrode structure according to another embodiment.

FIG. 6 is a graph of characteristic time scales in CDI device as function of electrode length scale.

FIG. 7 is an optical photograph of a cross section of a layered carbon electrode structure according one embodiment.

### DETAILED DESCRIPTION

Reference will now be made in detail to various embodiments of the invention, examples of which are illustrated in the accompanying drawings. Wherever possible, the same reference numbers will be used throughout the drawings to refer to the same or like parts.

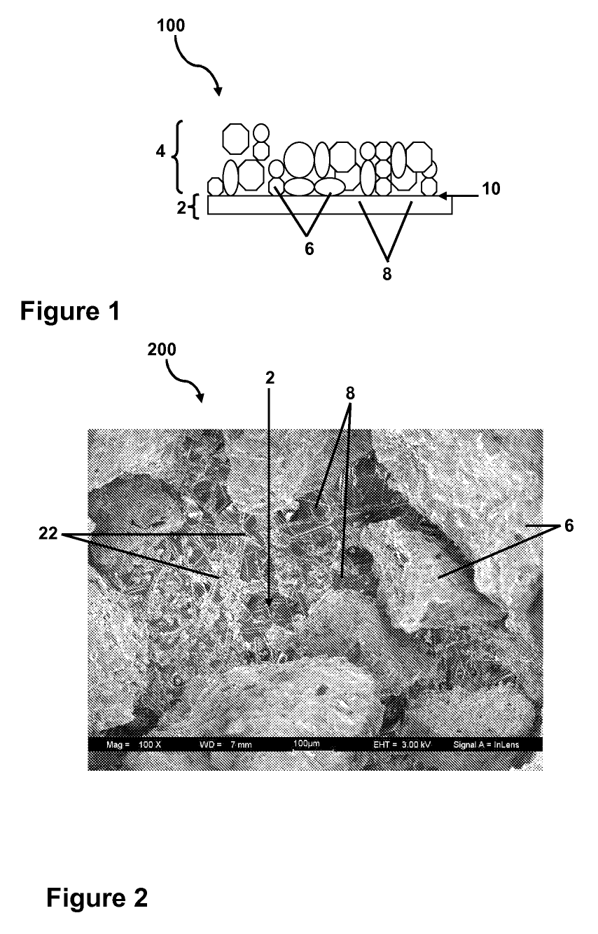

In one embodiment 100, as shown in FIG. 1, a layer 4 comprising carbon particles 6 is in contact with the electrically conductive porous layer 2, and a thermoplastic material 8 is infused in the electrically conductive porous layer 2 and provides a bond (not illustrated) to the carbon particles 6 at the interface 10 of the layers.

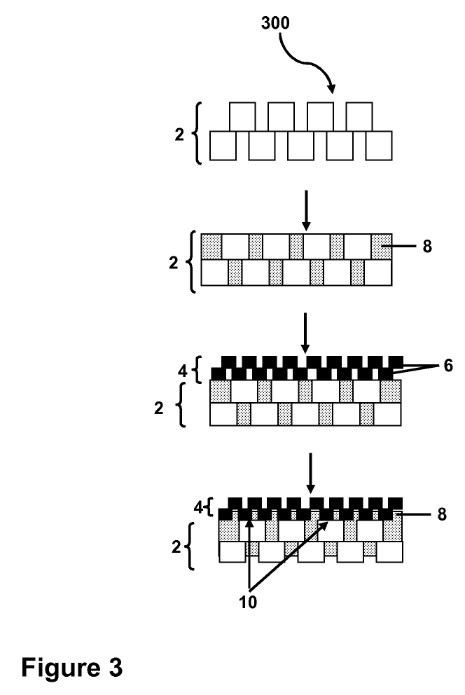

FIG. 3 shows an exemplary method 300 of making a layered carbon electrode according to another embodiment. The method comprises providing an electrically conductive porous layer 2, infusing the electrically conductive porous layer 2 with a thermoplastic material 8, applying an adjacent layer 4 comprising carbon particles 6 to the electrically conductive porous layer 2 infused with the thermoplastic material 8 and compressing and heating the layers such that the thermoplastic material 8 wicks from the electrically conductive porous layer 2 to bond with the carbon particles at the interface 10 of the layers 2 and 4.

According to another embodiment, the method further comprises removing any excess thermoplastic material from the surface of the electrically conductive porous layer after infusing the electrically conductive porous layer with the thermoplastic material. Removing any excess thermoplastic material exposes the conductive surface of the electrically conductive porous layer.

According to another embodiment, two surfaces of the electrically conductive porous layer infused with the thermoplastic material are in contact with separate respective layers comprising carbon particles, thus providing an adjacent layer comprising carbon particles on two sides of the layered carbon electrode. For example, the layered carbon electrode may comprise a planar electrically conductive porous layer sandwiched between adjacent layers comprising carbon particles.

According to another embodiment, a surface of the electrically conductive porous layer infused with the thermoplastic material is in contact with the carbon particles in a pattern, thus providing areas in the adjacent layer comprising carbon particles and areas in the same adjacent layer lacking the carbon particles. The pattern of carbon particles can be, for example, applied in discrete regions, periodic, in a pattern resembling a road map, or such that a bare area exists around the perimeter of a surface of the layered carbon electrode. Such bare areas of the electrically conductive porous layer can provide areas for electrical contact for the layered carbon electrode.

In one embodiment, the electrically conductive porous layer comprises a porous carbon sheet. One function of the porous carbon sheet is that of an electrical backplane or current collector. Therefore, it is advantageous that the electrically conductive porous layer have good electrical conductivity. Unfortunately, carbon is a modest electrical conductor in the best of cases. However, carbon possesses a high degree of electrochemical stability when used in a CDI environment, for example, in a fluid containing salt (NaCl).

Several materials currently used in the art have one or more of the following disadvantages: the materials either aggressively corrode or dissolve under electrical potential in saltwater or the materials are prohibitively expensive. The application of corrosion-resistant coatings to more reactive conductive materials does not seem practical, given the extremely aggressive nature of the mixed-ion saltwater capacitive deionization environment.

Fortunately, the electrical resistivity of carbon is sufficiently low that the ionic resistance of the high surface area carbon powder and the solution resistance of the saltwater render the materials utilized by the present invention, for example, carbon, advantageous.

In one embodiment, the electrically conductive porous layer is, for example, a porous carbon sheet which can take several forms, for example, carbon paper, carbon fibers, synthetic fiber carbon felt, carbon foam or combinations thereof.

A SEM image of one embodiment of a carbon electrode 200 is shown in FIG. 2. In this embodiment, a polyacrylonitrile (PAN) fiber based carbon paper manufactured by Toray is the electrically conductive porous layer. This PAN fiber based carbon paper comprises carbon fibers 22, and is highly porous (comprising approximately 80% porosity by volume of the paper) with low resistivity (approximately 5.6 mohm-cm), making the PAN fiber based paper a suitable electrically conductive porous layer 2 and as a reservoir in which to infuse the thermoplastic material 8 for bonding of the carbon particles 6.

According to another embodiment, a synthetic fiber carbon felt can be used as the electrically conductive porous layer. This material could provide a cost reduction to the manufacturing of the layered carbon electrodes when compared to the costly PAN fiber based carbon paper. The infused thermoplastic material used in the layered carbon electrodes should greatly strengthen and toughen the synthetic fiber carbon felt, making it useful for CDI applications where the PAN fiber based paper could otherwise prove too fragile.

Toray TGP-H-090 carbon paper is a PAN fiber based paper made by Toray Marketing and Sales, 461 Fifth Ave., 9th Fl., New York, N.Y. Fiber based papers manufactured by Toray are commercially available at 190, 280 and 370 microns in thickness. The electrically conductive porous layer according to other embodiments can comprise a planar surface which is, for example, 50 to 500 microns in thickness or 150 to 400 microns in thickness.

According to another embodiment, carbon foam, for example PocoFoam available from Poco Graphite, Inc. can be used as the electrically conductive porous layer.

The thermoplastic material 8, as shown in FIG. 2 should readily wet both the electrically conductive porous layer 2 and the carbon particles 6 in the layer adjacent to the electrically conductive porous layer comprising carbon particles. The thermoplastic material should wet the electrically conductive porous layer when melted and infiltrate the pore structure, thus becoming infused in the pore structure. Upon application of the adjacent layer comprising carbon particles, and upon application of compression and heat, the thermoplastic material should wick out of the pores of the electrically conductive porous layer and wet the carbon particles forming fillets there between.

The thermoplastic material should not be of such a low viscosity or have such a high tendency to wet the carbon particles that the thermoplastic material coats the surface of the carbon particles which will be exposed to the fluid stream and/or deeply infiltrates the adjacent layer comprising the carbon particles. Deep infiltration could compromise the electric double layer properties of the carbon particles.

According to one embodiment, the viscosity for the thermoplastic material is 750-25,000 centipoise (cP) at the processing temperature.

In another embodiment, the viscosity for the thermoplastic material is 2000-10,000 centipoise at the processing temperature.

The processing temperature is the temperature the thermoplastic material reaches as the layered carbon electrode is made. This includes the temperature of the thermoplastic material as it is infused in the electrically conductive porous layer, and the temperature of the thermoplastic material when the layers are compressed and heated. Example processing temperatures may include temperatures ranging from 150 degrees Celsius (° C.) to 500° C., 175° C. to 250° C. and 175° C. to 225° C., for example.

For example, viscosities were measured for exemplary thermoplastic materials using a Rheometrics Rheometer, RDA-II in dynamic mode with 25 mm parallel plates. One exemplary thermoplastic material, Hysol Product 7804, was found to have a viscosity of 20,500 cps when heated to a temperature of 177.6° C. Another exemplary thermoplastic material, Hysol Product 7901, was found to have a viscosity of 3,213 cps when heated to a temperature of 204° C.

It is advantageous that the thermoplastic material have good resistance to the saltwater environment of the CDI operation, a characteristic shared by a large number of thermoplastics, for example, polyethylene and polystyrene, which are widely used in water and food applications. The thermoplastic material should be able to be reflowed after the application of the adjacent layer comprising carbon particles in contact with the electrically conductive porous layer and be fluid enough to wet and bond the carbon particles to the electrically conductive porous layer.

The thermoplastic material, for example can be simple multi-temperature hot melt glue sticks available at virtually any department store or craft store. However, these hot melt glue sticks contain waxes and may not be suitable for long term commercial applications.

Suitable thermoplastic materials which are free of waxes are, for example, a polyamide, a polyolefin, polyethylene and polystyrene, thermal cure epoxy, UV cure epoxy, a conductive polymer and combinations thereof.

According to one embodiment, Hysol Product 7804, (Loctite Corp., 1001 Trout Brook Crossing, Rocky Hill, Conn.), a commercial polyamide-based hot melt adhesive, possesses characteristics which are well suited to the fabrication of the carbon electrodes described herein.

According to another embodiment, other polyamide materials, for example, Hysol Products 7809 and 7811, additional grades of polyamide adhesive, can be used in making the carbon electrodes according to the present invention.

In another embodiment, other polyamide materials, for example, HMT Products 0281 and 0288 (Hot Melt Technologies, Inc. 1723 W. Hamlin Road, P.O. Box 80067, Rochester, Mich.), are polyamide-based hot melt adhesives, with working viscosities of 4000 cP, which can be used in making the carbon electrodes according to the present invention.

Further, in another embodiment, thermoplastic materials such as polyolefins, for example, HMT Product 4177 (Hot Melt Technologies, Inc.), which is a polyolefin-based hot melt adhesive, with a working viscosity of 6500 cP, can be used in making the carbon electrodes according to the present invention.

According to another embodiment, other types of thermoplastic material, such as a low viscosity thermal cure or ultraviolet (UV) cure epoxy can be used. Conductive thermoplastic polymers might also provide an attractive solution, should their electrical performance and electrochemical durability reach a state that would allow their use in making a carbon electrode according to the present invention.

The processing temperature of the thermoplastic material should be sufficiently low such that minimal thermally-induced damage occurs to either the electrically conductive porous layer or to the carbon particles in the adjacent layer. When the thermoplastic material is applied in an air environment, processing temperatures should be below 500° C., in order to minimize oxidation that can occur to the carbon particles. However, a controlled environment can be used comprising a non-oxidizing cover gas, for example nitrogen, argon, other non-oxidizing cover gases or combinations thereof which would allow processing temperatures of 500° C. or more. The use of the cover gas minimizes oxidation and could enable the use of high temperature adhesives by increasing the processing temperatures.

The method of making the layered carbon electrode comprises compressing and heating the layers such that the thermoplastic material wicks from the electrically conductive porous layer to bond with the carbon particles at the interface of the layers.

The compressing and heating can be performed simultaneously or subsequent to each other, for example, heating then compressing; compressing then heating; or compressing and heating at the same time.

According to one embodiment, in order to insure electrical contact between the carbon particles and the electrically conductive porous layer, mechanical pressure is applied while the thermoplastic material wicks and forms the bond with the carbon particles at the interface of the layers.

The applied pressure should be sufficiently high so as to bring the carbon particles and the electrically conductive porous layer into intimate mechanical contact and facilitate wicking of the thermoplastic material to provide a bond between the two, but not so high so as to cause significant crushing damage to either the carbon particles or the electrically conductive porous layer. The level of the applied pressure can be adjusted depending on the specific electrically conductive porous layer and the carbon particles used.

In one embodiment, the application of 70 or more gram-force/square centimeter to 280 or less gram-force/square centimeter to a rigid metal plate placed on top of the adjacent layer comprising carbon particles on the infused electrically conductive porous layer is sufficient to obtain the level of electrical contact for the intended application without causing unnecessary damage to either the carbon particles or the electrically conductive porous layer. Damage such as fracturing the carbon particles or pushing the carbon particles through the electrically conductive porous layer are examples of such damage. Micro-cracking of the layers is another example of potential damage.

In another embodiment, a soft, compliant surface on the rigid metal plate could allow distribution of the applied force over a greater number of carbon particles and a greater surface area per carbon particle. This in turn should allow the application of higher pressures when the layers are compressed.

According to one embodiment, in the adjacent layer comprising carbon particles, high surface area carbon powder provides the capacitive element of the layered carbon electrodes. As mentioned above, this concept is powder-agnostic: virtually any carbon powder can be used as the source of carbon particles as long as the carbon particles are of acceptable particle sizes. For example, Norit GAC 1240 made by NORIT Americas, 3200 University Avenue, Marshall, Tex. can be used as the carbon particles. As purchased, the carbon particles are typically outside the useful range (too large) as described by the present invention. The carbon particles can be milled into useful sizes. Useful carbon particle sizes are described below.

In one embodiment, the layered carbon electrode comprises carbon particles having an average diameter of from 10 microns to 1000 microns. In other embodiments, the layered carbon electrode comprises carbon particles having an average diameter of from 75 microns to 600 microns. In other embodiments, the layered carbon electrode comprises carbon particles having an average diameter of from 150 microns to 420 microns in diameter.

If the carbon particles have average diameters of less than 10 microns, the surface of the electrically conductive porous layer infused with the thermoplastic material may be compromised. When heat is applied to the electrically conductive porous layer infused with the thermoplastic material, the remelted thermoplastic material may be unable to wick through a continuous layer of fine particles, so only a very low mass loading of the carbon particles would be realized. As a result, the layered carbon electrode would possess relatively little capacitance.

Conversely, if the carbon particles have average diameters greater than 1000 microns, they may be tenuously bonded to the electrically conductive porous layer. The tenuously bonded carbon particles tend to break loose from the electrically conductive porous layer and can present a shorting hazard between adjacent layered carbon electrodes in a layered carbon electrode structure. Carbon particles comprising average diameters of from 150 microns to 420 microns, yield advantageous particle mass loadings and optimized adhesion to the electrically conductive porous layer.

This flexibility in useful average carbon particle sizes is advantageous over the conventional resorcinol/formaldehyde monolithic aerogel electrodes, which have a limited working range of microstructures.

In the embodiment comprising carbon particles having an average diameter of from 10 microns to 1000 microns, it is also recognized that particles comprising carbon or other materials can be utilized which comprise average particle sizes of less than 10 microns or larger than 1000 microns included in the layer comprising carbon particles of the present invention. The smaller particles, for example, nanoparticles, would not compromise the capacitive performance of the carbon electrode provided that the carbon particles in the adjacent layer comprise an average diameter of from 10 microns to 1000 microns.

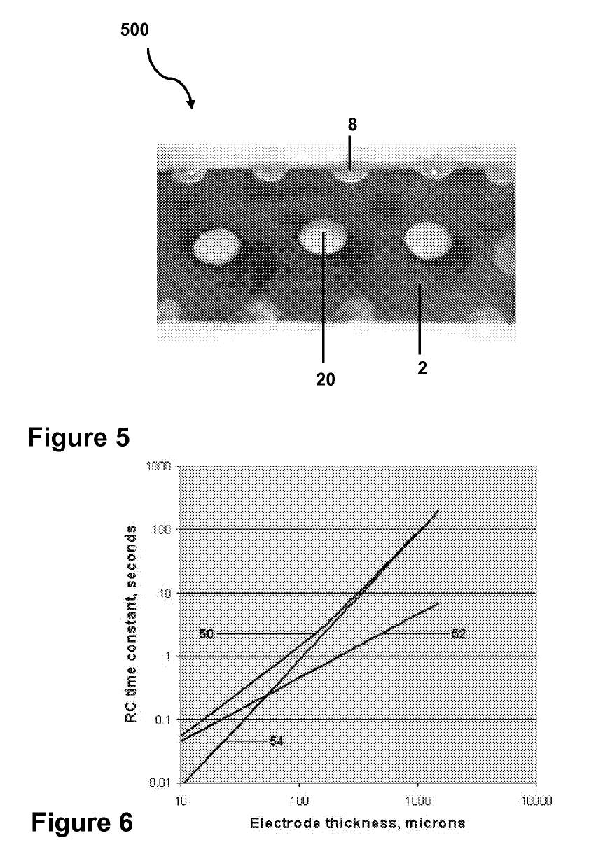

An advantage of the layered carbon electrodes described by the present invention is the mechanical stiffness and fracture toughness of the layered carbon electrodes. This facilitates the processing of the carbon electrodes into several geometric designs, for example, parallel, transverse, or hybrid parallel/transverse flow geometries. FIG. 5 is a photograph of a layered carbon electrode structure, according to another embodiment, wherein two layered carbon electrodes according to the present invention are combined into a certain multilayered layered electrode structure comprising a non-conductive porous separation layer, for example, a fabric filter.

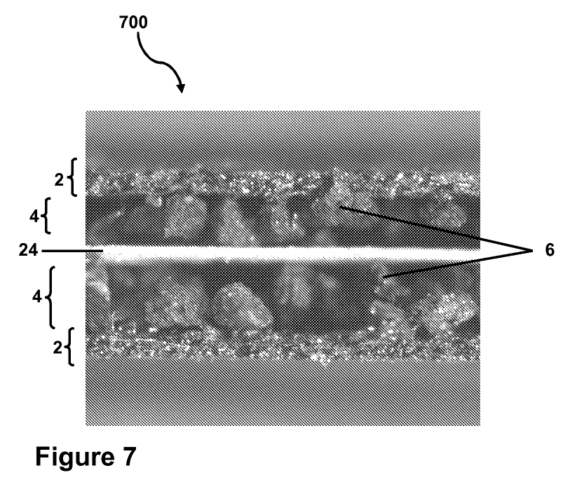

FIG. 7 is an optical photograph of a cross section of the layered carbon electrode structure 700 shown in FIG. 5. The respective adjacent layers 4 comprising carbon particles 6 are sandwiched between the respective electrically conductive porous layers 2 and separated by the fabric filter 24. Further, as shown in FIG. 5, the layered carbon electrode structure 500 comprises a hole 20 extending through the thickness of the structure. The holes can be arranged in an array in each carbon electrode structure, with the holes in multiple alternating carbon electrodes being offset from one another. This geometric design can be used to develop a hybrid CDI cell, where fluid flows both through and between multiple layered carbon electrodes consecutively. An electrode with the above described geometry comprises short flow paths within individual capacitive interfaces, could demonstrate enhanced performance as compared to a conventional CDI cell.

In order to achieve the highest levels of performance from a CDI cell comprising electrodes, the development CDI electrodes which possess a high level of specific capacitance and a low equivalent series resistance is advantageous. The specific capacitance is essentially the electric double layer (EDL) capacitance (expressed in Farads per grams) developed at the electrodes due to electrostatic adsorption of the counter-ions. Electrodes with increased “accessible” specific surface area (m²/g) are advantageous for developing a high performance CDI cell. The total charge stored and hence the total amount of NaCl separated is proportional to the specific surface area. While the amount of charge separated is proportional to the specific surface area, the rate at which the charge is separated (or NaCl removed) is dependent on the total equivalent series resistance (ESR), R, between the two electrodes. The ESR is a linear function of three resistances represented by Formula I as follows:

$$R = {R}_{el} + \frac{{L}_{S}}{{K}_{S}} + \frac{{L}_{e}}{σ + {K}_{P}} \qquad I$$

wherein, Rₑₗ is the electronic resistance between the two electrodes (external circuit and contact between electrode and wire);

L_{S} is the gap between the two electrodes through which the fluid stream flows;

κ_{S} is the ionic conductivity of the solution between the two electrodes;

Lₑ is the thickness of the electrodes;

σ is the electronic conductivity of activated carbon; and

κ_{P} is the “effective” ionic conductivity of the solution in the porous matrix.

The Rₑ term is usually significantly smaller than the latter two terms and is neglected. However, the electronic resistance could be high in the case of poor contact between the wire and the electrode due to the existence of voids, micro-cracks and other such defects. In the present invention, a conducting backplane (i.e. the electrically conductive porous layer) is utilized which minimizes the likelihood of high contact resistance.

The second term is the resistance to migration of the ions towards their counter-electrodes in the bulk fluid stream flowing between the electrodes and is directly proportional to the separation distance between the electrodes and is inversely proportional to the ionic conductivity of the ions.

The latter is a complex function of the molecular diffusivities and charges of the ions and the viscosity of the solution (Stokes-Einstein) and is usually high enough to render the second term much smaller than the third term. This resistance term could be reduced even more by reducing the gap between the electrodes. The third term is the resistance to ion transport within the porous network of the electrode and is inversely proportional to the electronic conductivity of the electrode material and the effective conductivity of the solution inside the pores.

If the volumetric specific capacitance of the electrode is aC (Farads/cm³), then the capacitance per area of each EDL in the electrodes is represented by Formula II as follows:

C=(aC)Lₑ II

Hence the RC time constant can be represented by Formula III as follows:

$$Γ ∼ {Γ}_{S} + {Γ}_{P} ∼ ( aC ) \frac{{L}_{e} {L}_{S}}{{K}_{S}} + ( aC ) \frac{{L}_{e}^{2}}{σ + {K}_{P}} \qquad III$$

wherein Γ_{S} and Γ_{P} are the characteristic time constants of migration of ions towards the counter-electrodes in the fluid stream between the electrodes and the characteristic time scale of ion transport within the porous electrodes respectively. Γ_{S} and Γ_{P} are scaled linearly and quadratically with respect to electrode thickness.

In FIG. 6, the calculated representative values of Γ_{S} and Γ_{P} and Γ (order of magnitude) as a function of electrode thickness are shown. The characteristic time scales in CDI device as function of electrode length scale. The plot 54 is the characteristic time constant of ion transport in the pores, the plot 52 is the characteristic migration time scale of ions in the fluid stream between the electrodes. The plot 50 is the overall time scale of the CDI system.

As shown in FIG. 6, the electrode separation is 100 microns, and the solution concentration is 1500 ppm. The overall time constant is dominated by the pore time constant when the electrode length scale is larger than 200 microns and the resistance due to the liquid bridge between the two electrodes for all practical purposes does not contribute. For electrode length scale less than 100 microns, the overall time constant is dominated by the migration time constant (in the liquid bridge between the electrodes) and the electrode resistance does not contribute significantly to the overall time scale. While the cross-over point where pore time constant and migration time constant are about the same magnitude corresponds to electrode thickness of approximately 100 microns in these calculations (separation gap of 100 microns), it will vary if the separation gap between the electrodes is changed. The cross-over point depends on the separation distance between the two electrodes and can increase or decrease significantly as the electrode separation distance is increased or decreased.

The layered carbon electrodes according to the present invention have increased electrical conductivity as compared to conventional electrodes, in part due to the integrated electrical backplane provided by the electrically conductive porous layer. The carbon electrodes possess increased capacitive performance, resulting from highly effective utilization of the carbon particles. In part because of their good mechanical strength and toughness, the layered carbon electrodes may incorporate an array of punched holes, which can be used to enable a hybrid parallel/transverse flow-through CDI cell. Further, layered carbon electrodes of the present invention provide an opportunity for cost reduction in their manufacturing as compared to conventional electrodes.

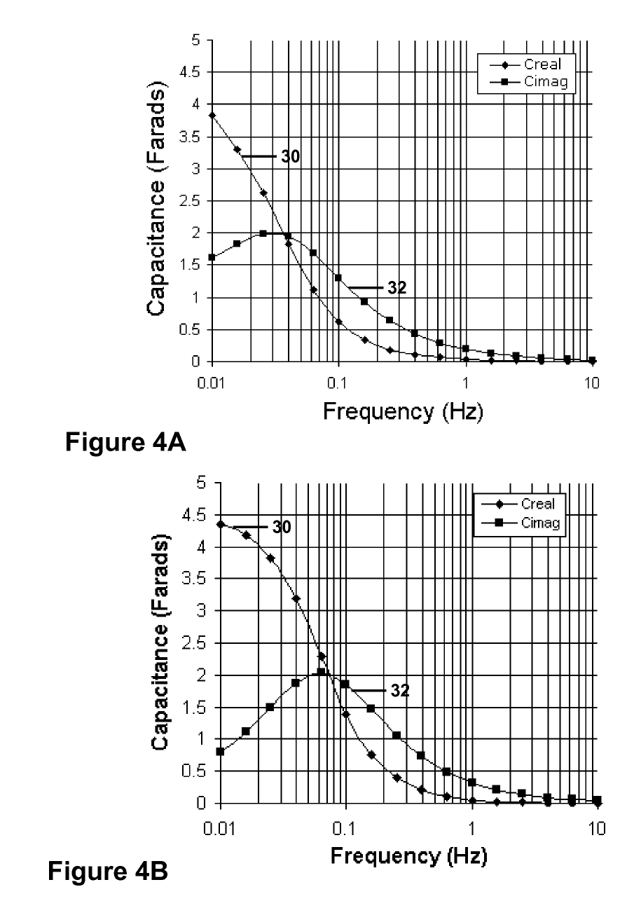

FIG. 4A and FIG. 4B are graphs comparing electrochemical impedance spectroscopy (EIS) test results for carbon electrodes according to the present invention (FIG. 4B) as compared to a commercially available electric double layer capacitor (EDLC) of similar physical scale (FIG. 4A). In both FIG. 4A and FIG. 4B, Creal 30 is capacitance which represents the electromagnetic (EM) field produced in the device and provides recoverable stored energy while Cimag 32 is apparent capacitance which is actually dissipative loss. It may be seen by comparing FIG. 4A and FIG. 4B that the laboratory device comprising layered carbon electrodes made according to the present invention displays a capacitance level and frequency response similar to a commercially available EDLC.

What is claimed is:

1. A layered carbon electrode comprising:
an electrically conductive porous layer;
an adjacent layer comprising carbon particles in contact with the electrically conductive porous layer; and
a thermoplastic material infused in the electrically conductive porous layer and providing a bond to the carbon particles at the interface of the layers.

2. The layered carbon electrode according to claim 1, wherein the electrically conductive porous layer comprises a planar surface.

3. The layered carbon electrode according to claim 1, wherein the electrically conductive porous layer comprises carbon paper, carbon fibers, synthetic fiber carbon felt, carbon foam or combinations thereof.

4. The layered carbon electrode according to claim 3, wherein the electrically conductive porous layer comprises a planar surface from 50 to 500 microns in thickness.

5. The layered carbon electrode according to claim 4, wherein the electrically conductive porous layer is from 150 to 400 microns in thickness.

6. The layered carbon electrode according to claim 1, wherein the carbon particles have an average diameter of from 10 microns to 1000 microns.

7. The layered carbon electrode according to claim 6, wherein the carbon particles have an average diameter of from 75 microns to 600 microns.

8. The layered carbon electrode according to claim 6, wherein the carbon particles have an average diameter of from 150 microns to 420 microns.

9. The layered carbon electrode according to claim 1, wherein the thermoplastic material has a viscosity of 750 to 25,000 centipoise (cP) at a temperature in the range of from 150° C. to 500° C.

10. The layered carbon electrode according to claim 9, wherein the thermoplastic material has a viscosity of 2000 to 10,000 centipoise at a temperature in the range of from 150° C. to 500° C.

11. The layered carbon electrode according to claim 1, wherein the thermoplastic material comprises a material selected from a polyamide, a polyolefin, polyethylene, polystyrene, thermal cure epoxy, UV cure epoxy, a conductive polymer and combinations thereof.

12. The layered carbon electrode according to claim 1, wherein the electrode comprises a hole extending through the thickness of the electrode.

13. The layered carbon electrode according to claim 12, wherein the hole is from 1 mm to 10 mm in diameter.

14. The layered carbon electrode according to claim 1, wherein the carbon particles form a pattern comprising areas of the carbon particles adjacent to bare areas of the electrically conductive porous layer.

15. A method for making a layered carbon electrode, the method comprising:
providing an electrically conductive porous layer;
infusing the electrically conductive porous layer with a thermoplastic material;
applying a layer comprising carbon particles to the electrically conductive porous layer infused with the thermoplastic material;
compressing and heating the layers such that the thermoplastic material wicks from the electrically conductive porous layer to bond with the carbon particles at the interface of the layers.

16. The method according to claim 15, wherein the electrically conductive porous layer comprises carbon paper, carbon fibers, synthetic fiber carbon felt, carbon foam or combinations thereof.

17. The method according to claim 15, further comprising:
removing any excess thermoplastic material from the surface of the electrically conductive porous layer after infusing the electrically conductive porous layer with the thermoplastic material.

18. The method according to claim 15, comprising compressing the layers at a pressure of 70 or more gram-force/square centimeter.

19. The method according to claim 15, comprising compressing the layers at a pressure of 280 or less gram-force/square centimeter.

20. A multilayered carbon electrode comprising:
a first outer layer of an electrically conductive porous layer;
a first intermediate adjacent layer comprising carbon particles in contact with the first outer layer;
a second outer layer of an electrically conductive porous layer;
a second intermediate adjacent layer comprising carbon particles in contact with the second outer layer;
a non-conductive porous inner layer in contact with the first and second intermediate layers on opposing sides of the non-conductive porous inner layer; and
a thermoplastic material infused in the first and second electrically conductive porous layers and providing a bond to the carbon particles at the interface of the electrically conductive porous layers and the adjacent first and second intermediate layers, respectively.
